(19) United States
(12) Patent Application Publication
(10) Pub. No.: US 2003/0123020 A1
(43) Pub. Date: Jul. 3, 2003

(54) Method of dividing an exposing region

(76) Inventors: Ming-Tien Lin, Taipei Hsien (TW); Te-Cheng Chung, Taoyuan Hsien (TW); Tean-Sen Jen, Taoyuan Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/237,442

(22) Filed: Sep. 9, 2002

(30) Foreign Application Priority Data
Jan. 2, 2002 (TW) 91100009

(51) Int. Cl. G02F 1/13

(52) U.S. Cl. 349/187

(57) ABSTRACT

A method of dividing the exposure region for a liquid crystal display panel. This method is characterized in that the exposure region is divided into a first shot, a second shot, a third shot, and a fourth shot, wherein each of the shots is adjacent to any other two shots, and the overlap region of the first to fourth shots is designed by two-dimensional gradation.

### BACKGROUND OF THE INVENTION

1. Field of the Invention

The present invention relates to the manufacture of a liquid crystal display panel (LCD panel), more particularly, to a method of dividing the exposure region into four shots for the pixels of the liquid crystal display panel. The method is capable of eliminating shot Mura by using two-dimensional gradation at the center overlap region of the four shots.

2. Description of the Related Art

An active matrix type liquid crystal display panel comprises an array substrate, an opposite substrate, and a liquid crystal material. A pixel electrode array is formed on the array substrate. An opposite electrode is formed on the opposite substrate. The liquid crystal material is disposed between the array substrate and the opposite substrate. The TFTs and the pixel electrodes connected thereto are formed on the array substrate in a matrix shape. These electrodes and TFTs are conventionally fabricated by photolithography followed by etching.

As the display areas of the liquid crystal display panel increase, needs of patterning technologies for fabricating the electrode and TFTs become stronger. When the panel area is larger than that of the photo mask, so-called division exposure (stepper) is employed. That is to say, one display area is divided into a plurality of shots followed by exposure using the stepper. Traditionally, a 14-inch liquid crystal display panel is divided into six shots.

When the same image signal is input to pixels in different exposure areas, the luminances thereof may be different from each other. In particular, when the difference in luminances in adjacent exposure areas is large, the boundary line of each exposure area is viewed as a seam, namely shot Mura. That is to say, the difference in luminances is easily observable.

U.S. Pat. No. 5,784,135 to Inada, et al. discloses a display device in which display regions have non-linear boundaries, solving the luminance defect viewed as a “seam”. In the display device, so-called one-dimensional gradation cut is utilized. The liquid crystal display device has a screen for equally displaying an image. According to the method of the prior art, the non-linear boundary line is formed so that pixels in different exposure areas are mixed in a boundary area thereof so as to equalize the apparent difference in luminances of pixels in the vicinity of the boundary line.

However, luminance defects are still perceived in the overlap region of four shots using the method of one-dimensional gradation.

Therefore, improved methods of dividing the exposure region for a liquid crystal display panel are needed.

### SUMMARY OF THE INVENTION

In view of the above disadvantages, an object of the invention is to provide a method of dividing the exposure region for a liquid crystal display panel. According to the method, the difference in luminances in adjacent exposure areas, especially in the overlap region of four shots, is minor and not obvious. As a result, when the same image signal is input to pixels in different exposure areas, the image viewed is the same.

In accordance with one aspect of the invention, there is provided a method of dividing the exposure region of a liquid crystal display panel, characterized in that the exposure region is divided into a first shot, a second shot, a third shot, and a fourth shot, wherein each of the shots is adjacent to any other two shots, and the overlap region of the first to fourth shots are designed by two-dimensional gradation.

In accordance with another aspect of the invention, the overlap width of each adjacent shot is about 2 to 20 mm.

In accordance with a further aspect of the invention, the pixels in the overlap region are randomly exposed by any one of the first to fourth shots. Preferably, the exposed density distribution of the pixels in the overlap region is gradually reduced toward to the diagonal shot.

In accordance with yet another aspect of the invention, any two of the adjacent shots are designed by one-dimensional gradation.

In accordance with a still further aspect of the invention, the overlap region of the first to fourth shots can be cross-shaped.

In accordance with a still further aspect of the invention, the liquid crystal display panel is preferably an active matrix liquid crystal display panel.

### BRIEF DESCRIPTION OF THE DRAWINGS

The preferred embodiment of the invention is hereinafter described with reference to the accompanying drawings in which:

FIG. 1 is a diagram showing a liquid crystal display panel having six shots and their overlap regions according to the embodiment of the invention.

FIG. 2 is an enlarged diagram of Z portion of FIG. 1 showing the concepts for dividing the exposure region near a part of overlap region according to the embodiment of the invention.

### DETAILED DESCRIPTION OF THE INVENTION

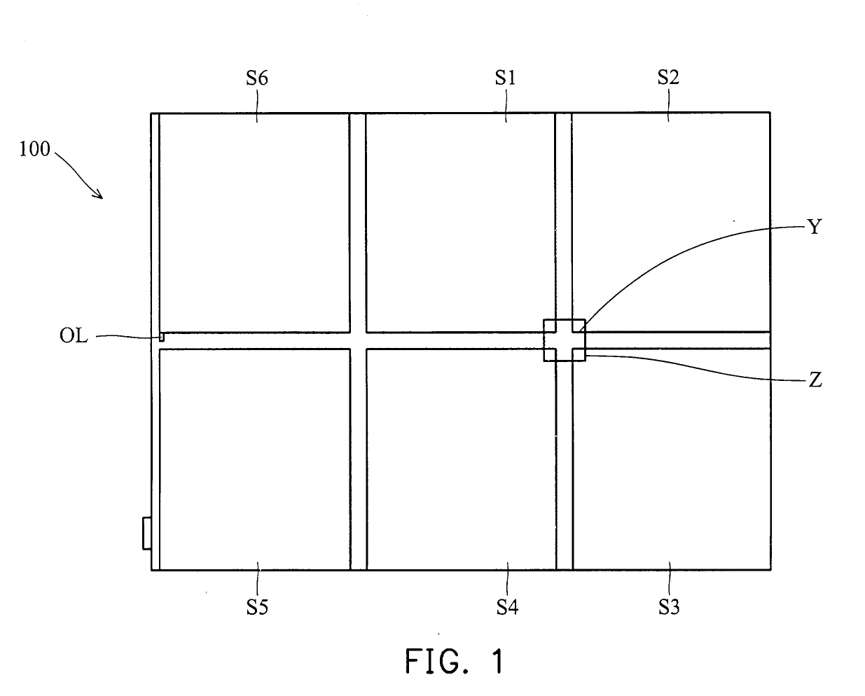

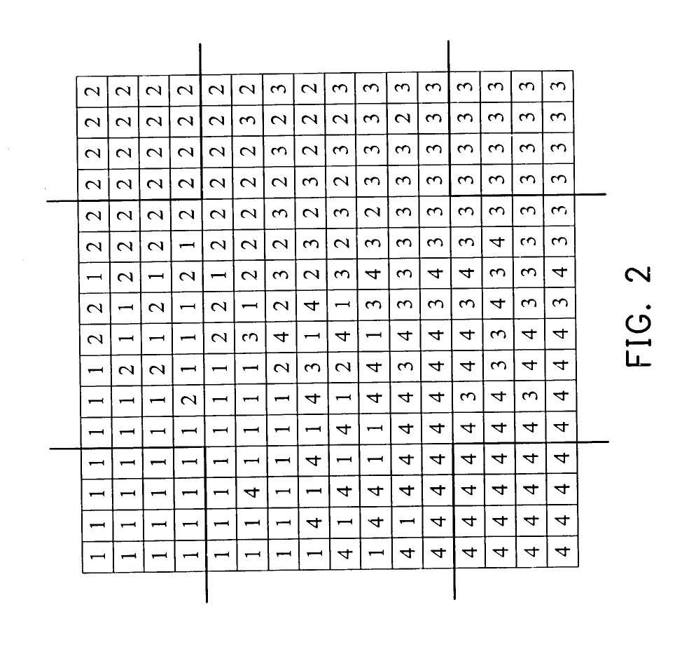

FIG. 1 and FIG. 2 show a liquid crystal display panel having six shots and their overlap regions according to the embodiment of the invention.

Electrodes and semiconductor devices are formed on the array substrate for the active matrix type liquid crystal display device. These electrodes and semiconductor devices such as TFTs are conventionally fabricated by thin film pattern forming technologies, namely deposition, photolithography, and etching.

In a conventional thin film pattern forming process, a thin film material is formed on a substrate by a particular film forming method such as sputtering or chemical vapor deposition (CVD). The thin film is patterned in a desired shape by photolithography and etching. In other words, a photoresist layer is coated on the thin film formed on the substrate. Afterward, a photomask is aligned on the upper surface of the substrate. Rays of light are exposed to the substrate through the photomask. Thereafter, the exposed photoresist is developed. With a mask of the developed photoresist, the undesired portion of the thin film formed on the substrate is etched out and a desired pattern is obtained. By repeating these processes a number of times corresponding to the number of layers of thin films that construct the electrodes and semiconductor devices, the desired device can be fabricated.

As shown in FIG. 1, the liquid crystal display panel 100 is divided into six shots S1, S2, S3, S4, S5, and S6. Overlap region OL between each adjacent shot has a width of about 2 to 20 nanometers. Z portion is the overlap region among the shots S1, S2, S3, and S4.

FIG. 2 is an enlarged diagram of Z portion of FIG. 1 showing the concepts for dividing the exposure region near a part of overlap region. Z portion of the panel 100 includes a plurality of small squares having numerals of 1, 2, 3, and 4. The small squares with numeral 1 denote the region of shot S1 adjacent to shots S2 and S4. The small squares with numeral 2 denote the region of shot S2 adjacent to shots S1 and S3. The small squares with numeral 1 denote the region of shot S3 adjacent to shots S2 and S4. The small squares with numeral 4 denote the region of shot S4 adjacent to S1 and S3. Also, each square comprises R, G, and B pixels.

When the first exposure for shot S1 is conducted, the small squares with numerals 2, 3, and 4 are shielded and masked. When the second exposure for shot S2 is conducted, the small squares with numerals 1, 3, and 4 are shielded and masked. When the third exposure for shot S3 is conducted, the small squares with numerals 1, 2, and 4 are shielded and masked. When the fourth exposure for shot S4 is conducted, the small squares with numerals 1, 2, and 3 are shielded and masked.

The exposure density of one of the shots S1, S2, S3, and S4 is gradually reduced toward the shot positioned in its diagonal line. For example, the exposure density of shot S1 is gradually reduced toward shot S3 which is not adjacent to shot S1.

As shown in Y portion, in the shape of a cross, of FIG. 1, the pixels in the Y portion are made of shots S1 to S4. Namely, the pixels in the Y portion are fabricated by one of the shots S1 to S4, so that the difference in luminances in adjacent exposure areas is minor and not obvious. As a result, when the same image signal is input to pixels in different exposure areas, the image viewed is the same.

While the invention has been described with reference to various illustrative embodiments, the description is not intended to be construed in a limiting sense. Various modifications of the illustrative embodiments, as well as other embodiments of the invention, will be apparent to those skilled in the art upon reference to this description. It is therefore contemplated that the appended claims will cover any such modifications or embodiments as may fall within the scope of the invention defined by the following claims and their equivalents.

What is claimed is:

1. A method of dividing an exposure region for a liquid crystal display panel, characterized in that:
the exposure region is divided into a first shot, a second shot, a third shot, and a fourth shot, wherein each of the shots is adjacent to any other two shots, and an overlap region of the first to fourth shots is designed by two-dimensional gradation.

2. A method of dividing an exposure region as claimed in claim 1, wherein the overlap region has a width of about 2 to about 20 mm.

3. A method of dividing an exposure region as claimed in claim 1, wherein the overlap region has a plurality of pixels being randomly exposed by any one of the first to fourth shots.

4. A method of dividing an exposure region as claimed in claim 3, wherein the exposed density distribution of the pixels in the overlap region has a density distribution which is gradually reduced toward to the diagonal shot.

5. A method of dividing an exposure region as claimed in claim 1, wherein any two of the adjacent shots are designed by one-dimensional gradation.

6. A method of dividing an exposure region as claimed in claim 1, wherein the overlap region of the first to fourth shots is cross-shaped.

7. A method of dividing an exposure region as claimed in claim 1, wherein the liquid crystal display panel is an active matrix liquid crystal display panel.
